(19) United States
(12) Patent Application Publication
(10) Pub. No.: US 2007/0036683 A1
(43) Pub. Date: Feb. 15, 2007

(54) Emissions meter

(75) Inventor: David Hirst, Brighton (GB)

Correspondence Address: CANTOR COLBURN, LLP, 55 GRIFFIN ROAD SOUTH, BLOOMFIELD, CT, 06002, US

(73) Assignee: ECAMETER LTD, Brighton (GB)

(21) Appl. No.: 10/564,606

(22) PCT Filed: Jul. 15, 2004
(86) PCT No.: PCT/EP04/07935

§ 371 Date: May 18, 2006

(30) Foreign Application Priority Data
Jul. 17, 2003 (GB) 0316761.6

(51) Int. Cl. G01N 31/00; G01N 1/22; G01N 1/26

(52) U.S. Cl. 422/88

(57) ABSTRACT

The present invention is an apparatus for measuring emissions. The apparatus comprises means for obtaining a sample flow, which is a controlled proportion of the total emissions to be measured, and means for accumulating the sample flow in a tamper-proof container (or containers). The tamper-proof container may comprise known chemical reagents with which the accumulated samples react to provide a measure of one or more selected components within said sample. The tamper-proof container may comprise an inlet-port that is adapted to be sealed when said container is disconnected from receiving emissions and may further be adapted to be connected to an external device and to communicate with the external device to provide information about the emission measures. In addition to this, the tamper-proof container may also be removable, transportable and adapted to be connected to an external device under authorised conditions only, thereby providing a system for secure measurement and recordal of emissions.

The present invention is concerned with measuring emissions, for example, but not exclusively, ship emissions.

Reductions in fuel emissions to air from fuel engines is becoming increasingly important to the health and environmental well-being of many lands and peoples, yet creating regulations to achieve and monitor the reductions has proved a major challenge to those responsible.

For many forms of emissions (such as waste fluid, sewage, cargo outgas and cooling, scrubbing or ballast water), including fuel emissions to air, the harm they may create varies with location. A discharge in the mid-Atlantic may do no harm, whereas in a harbour or near land the harm might be substantial.

Regulations for the reduction in emissions to the atmosphere from ships are likely to come into force in 2004. The current proposals are to define Emissions Control Areas (ECAs)or Sea Emissions Control Areas (SECAs), which are areas of sea where the control of the pollution released to the atmosphere from ships is particularly important.

ECAs are sea areas within which emissions to air are particularly harmful, and where legislation requires the emissions from ships to be regulated. They are thus areas within which it is important to be able to measure the emissions from each source.

The International Maritime Organisation (IMO), which legislates on Maritime and thus shipping matters, has negotiated Annex VI of the MARitime POLlution (MARPOL) Convention of 1973 and 1978. MARPOL Annex VI defines the Baltic Sea as a Sulphur oxide Emissions Control Area (SECA), requiring either the fuel burned to include no more than 1.5% sulphur or that the emissions must include no more than 6 grams of Sulphur Oxide per kWh of energy produced. Restrictions such as these may be adopted in setting out future ECAs.

It is generally in the commercial interests of ships to use high sulphur fuel, which are cheaper than low sulphur fuels. Such fuels are plentiful and a very cheap form of raw energy. However, these create greater emissions. There is thus a direct conflict of interest between a regulator, who wishes to see low sulphur fuel used, and the ship, which wishes to use the lowest cost fuel.

Proposed regulations require certification of all bunker fuels for the sulphur content and various samples of the fuel to be retained. Such certification is most reliable when a ship is operating exclusively within a SECA. Most ships, however, will be travelling both within the SECA, where the certified sulphur content fuel must be used, and outside of the SECA where the ship will usually burn high sulphur fuel, to reduce costs. The assessment of the actual sulphur emissions within the SECA depends upon accurate records of the fuel used in the different zones. These records are often unreliable, especially as they may have been tampered with.

Furthermore, if a ship has Flue Gas Desulphurisation (FGD) equipment installed, the sulphur emissions released are far less than the sulphur consumed, and further assumptions about the efficiency (and operation) of the FGD equipment must be made. This renders the use of sulphur amounts in the fuel itself (rather than exhaust emissions) as a means of measuring the sulphur emissions of the ship even more unreliable.

Measurement of the concentration of gases by reacting or adsorbing samples of gases with a selected reagent, and then measuring the change in the reagent, is a well known technology, and is used to sample ambient air for a variety of pollutants. Two main technologies exist, the concentration of components can be measured by bringing a sample gas into controlled exposure to the reagent. By appropriate selection of reagent, the desired component is accumulated within the reagent, and so long as the exposure time and characteristics of the controlled exposure are known, then the concentration of the component in the sample gas can be inferred from the concentration of the component in the reagent. The accumulation may be by adsorption or other incorporation of the component within the reagent, in which case the change in weight may provide an indication of the level of the component present, or by causing chemical change in the reagent. The other technology involves choosing a reagent that changes colour when it is brought into contact with the component. The reagent can then be put in a glass tube, and the concentration in the sample can be inferred from the extent of the colour change in the reagent.

Shipping may create other forms of emissions which are waste or otherwise unwanted by the ship opearator and which may be harmful to the environment These include gasses from cargoes (such as Volatile Organic Compounds (VOCs) from oil), discharges of water that the vessel has used or carried, such as cooling, scrubbing or ballast water, and other waste fluids (such as sewage), suspensions, emulsions or compounds.

Market instruments, such as Emissions Trading, have proven effective in reducing emissions in other areas where emissions control must be regulated. The principle behind Emissions Trading is that any surplus in emissions reductions, above that required by law, can be traded like any other commodity. Emissions Trading allows vessels that can reduce their emissions more cheaply to trade their reductions to vessels for which reducing emissions is more expensive and not cost effective when compared to the cost of purchasing emissions reductions.

Emissions Trading enables the costs of emissions reductions to be minimised and at the same time ensures that, overall, the emissions target levels are reached.

The success of emissions regulation and Emissions Trading is reliant upon the ability to accurately and reliably record the emissions levels of ships. Measuring the sulphur levels of fuels used does not provide a reliable enough means to definitively determine the resulting emissions being released both inside and outside any ECAs. A measuring device is needed which can securely and reliably measure the actual emissions of the ships, perhaps only within an ECA.

At present, the available means for measuring emissions do not provide these advantages as they are either too delicate to cope reliably with the sometimes extreme conditions at sea or require skills and trust of personnel that can not always be found.

In many cases, in order to avoid having to pay for the processing, removal or disposal of any of the various ship emissions, the ship operator may decide it is more convenient to discharge the waste over the side of a ship. It is often to the disadvantage of the operator to have their behaviour monitored, and, when monitored, they will normally gain economically if the measurements understate the discharges.

It is critical, therefore, that the monitoring and measurement process can withstand or at least detect efforts by the operator to tamper with the results.

While, emissions to air from ship exhausts have been discussed thus far, there are other forms of ship emissions which could usefully be monitored. One example is called processed sea water, where shipboard processes use seawater, modify its properties in some way, and return it to the sea In some processes, the changed properties concern the chemical composition, and it may be desirable to monitor the extent of the chamical change.

An example process, which uses seawater, is exhaust gas scrubbing, where components of exhaust gasses are reacted with seawater, and returned to the sea. Sulphur compounds are harmless in seawater, but very harmful in air. However, the processed seawater may contain more harmful components, such as hydrocarbons or particles and it may be desirable to measure these pollutants. Furthermore, some sea areas or water bodies may have ecosystems or other characteristics that are less able to tolerate the processed water than others. For example, it may be appropriate to limit or prevent certain discharges within enclosed harbours.

Another example of water used on a ship where it may be desirable to measure the amount of any pollutants, or any other component of interest, is ballast water. Ballast water is water taken onto a ship to maintain its stability when the cargo on board is insufficient to do so. The water tends to be taken on when a ship is discharging or unloading, but then pumped out again when the ship loads or takes on cargo. Often, very large quantities of water are carried long distances. The ecosystems where the ballasts are filled may be very different from the ecosystems where they are discharged, and many life forms, from small fish down to microorganisms, may survive the journey, and so may be a threat to the receiving ecosystem.

The IMO has formed a Ballast Water Convention to stop the discharge of alien life forms into ecosystems to which they may be a threat. The standards are very demanding, and are expressed in terms of the number of “viable organisms” of defined sizes carried in each cubic meter of discharged water.

The standards can be met by a variety of means. For example, killing all relevant organisms using poison. Unfortunately, often the poisons are also harmful to the sea where the discharge takes place, and many organisms are quite resistant to attack in this way. Alternatively, the ballast water can irradiated usually using ultra-violet, which can kill or damage many life forms. The water treatment may be on-shore, so that either uncontaminated water is taken on as ballast, or the ballast water is discharged to treatment systems on-shore. Another option is to discharge the water, which may contain organisms, into the open ocean, and replace it with water from the open ocean, which is often very sparse in nutrients and, therefore, organisms.

Another form of emission from a ship is cargo outgassing. Many of the cargoes carried by ships are capable of outgassing components that may be harmful. Oil cargos, whether refined or crude or even residues, will tend to outgas their more volatile components, thereby creating Volatile Organic Compounds or VOCs that are released to the atmosphere. Many other cargoes can also outgas, and the resulting emissions may have adverse impacts on the atmosphere. If collected and prevented from being emitted, the resulting materials may be of value, but the collection process may cost more than the value of the cargo.

A further form of ship emission is sewage discharge. Many ships, particularly cruise ships, provide homes for large numbers of people, and so are potential sources of sewage far in excess of the levels expected in the waters to which they travel. This can be harmful to the environment, and, potentially, to human health. Various regulations, both voluntary and legislative, exist to discourage discharges, but the success of these regulations depends on the ability to reliably monitor the quality of any water discharged.

Many, if not all, of the above forms of ship emissions can be combatted, but this will usually involve some cost to the ship operator. Thus, there is commercial advatage to the ship operator in not taking measures to reduce the environmental damage caused by emissions. What is required, for successful regulation or measurement of emissions, is a tool to ensure users are not exceeding permissible or preferable emissions levels, and this requires reliable methods of measuring emissions and preventing those measurements or records of the measurements from being tampered with.

The emissions metering device of the present invention provides an accurate and reliable means for measuring emissions, which allows a more realistic and efficient regulation of emissions and may also be used to facilitate emissions trading to meet emissions restrictions. The emissions may then be automatically recorded, using a secure system, thus rendering reliance on the skills and trust of on-board personnel unnecessary. The device itself is secure to prevent any unauthorised access and tampering. Furthermore, the records of emissions may be logged externally, giving a secure and auditable account of the emissions of any ship etc. using the device, without the need for reliance on on-board record keeping.

In accordance with one aspect, the invention provides an apparatus for measuring emissions comprising:

means for obtaining a sample flow, the sample flow being a controlled proportion of the total emissions to be measured;

means for accumulating said sample flow in a tamper-proof container, said container further comprising known chemical reagents with which the accumulated samples react to provide a measure of one or more selected components within said sample.

It may be that several different components of the emission are to be measured, e. g. sulphur oxides and nitrogen oxides, in the case of gas emissions. In this case, different reagents will be used to detect the different components.

In one embodiment, the respective reagents will be contained within separate containers, both of which are contained in a single tamper-proof housing in which the sample is accumulated. Alternatively, a separate tamper-proof housing can be provided for each type of reagent.

Depending on the component to be measured, the sample may first be passed through a cleaning chemical or some other cleaning arrangement to remove components which might otherwise interfere with the accumulation of the component to be measured. By appropriate selection of chemicals and the sequence of the flow through them, a wide variety of components can be accumulated and measured.

Because, in some cases, it is not necessary to measure emissions in all geographical areas, the apparatus may be provided with means for switching the sampling off depending upon the location. Whilst this could be done manually, the system could be provided with automatic means for detecting the location and switching the system on or off accordingly.

Similarly, there may be applications in which it is only necessary for the system to be operated at certain times of the day or year. Again, the system could be switched on and off manually by an operator. Alternatively, an automatic timed determining system could be provided which is set to switch the device on and off at selected times.

Furthermore, it may be preferable, in certain situations, to carry out different types of measurements in different locations or at different times of the year. In such cases, the system may comprise multiple containers having chemical reagents which may or may not be different and switching means may be provided to direct the sample to one or other of these reagent containers according to location and/or time of year.

Whilst one embodiment of the system is described below in the context of measuring exhaust gas emissions from a single engine, it may be that, for example on ships, emissions from several engines need to be measured. In such cases, the means for obtaining the representative sample can be adapted to take extracts from the exhaust ducts of several engines and then to mix them, in proportion to the flow from each exhaust duct, then passing the combined sample to the means for accumulating.

The apparatus may also be provided with display means for providing a visual indication of the measurement.

The chemical reagents are preferably contained within one or more containers located within a tamper-proof removable canister. This canister is preferably locked inside a tamper-proof cabinet.

The apparatus is preferably provided with its own power system which may be, for example, a battery.

Whilst it is, of course, highly desirable that the emissions samples conveyed to the measuring equipment are a known proportion of the total emissions, there may be applications in which this is less important. The present invention, in a second aspect, provides means for accumulating emission samples in a secure manner. According to this second aspect, the invention provides a tamper-proof container having an inlet port adapted to receive emissions containing components to be measured, the inlet port adapted to be sealed when the container is disconnected for receiving emissions; the container further containing means for containing chemical reagents to provide an indication of the measure of one or more selected components in said emissions.

The container is preferably adapted to be connected to an external device and to communicate with said device to provide information about the emissions measurements.

The container may be adapted to be incorporated into the system of the first aspect of the invention and would then be adapted to be connected to the means for obtaining the sample. The interface between the container and the means for obtaining the sample must be such that it is sealed and secure. The same also applies to the interface between the container and an external device as mentioned above.

In many applications, it is essential that a secure processing chain exists between the taking of the samples, the measurement of the emissions and the analysis and recordal of such measurements.

Thus, according to a further aspect of the invention, there is provided a system for secure measurement and recordal of emissions comprising means for taking a representative sample of the emissions; secure, tamper-proof means for accumulating said samples and for storing chemical reagents which react with said samples and provide an indication of the quantity of selected components contained in the sample; the secure, tamper-proof means being removable under authorised conditions only and transportable and adapted to be connected to an external device under authorised conditions only. The removable device is preferably provided with encrypted identification means, particularly where the external device is in, for example, a laboratory, where emissions from various different sources are to be measured.

According to a further aspect of the invention, there is provided a tamper-proof container with means for locking the container, and means for unlocking the container by means of a signal from a mobile telephone.

Preferred embodiments will now be described, by way of example only, with reference to the drawings.

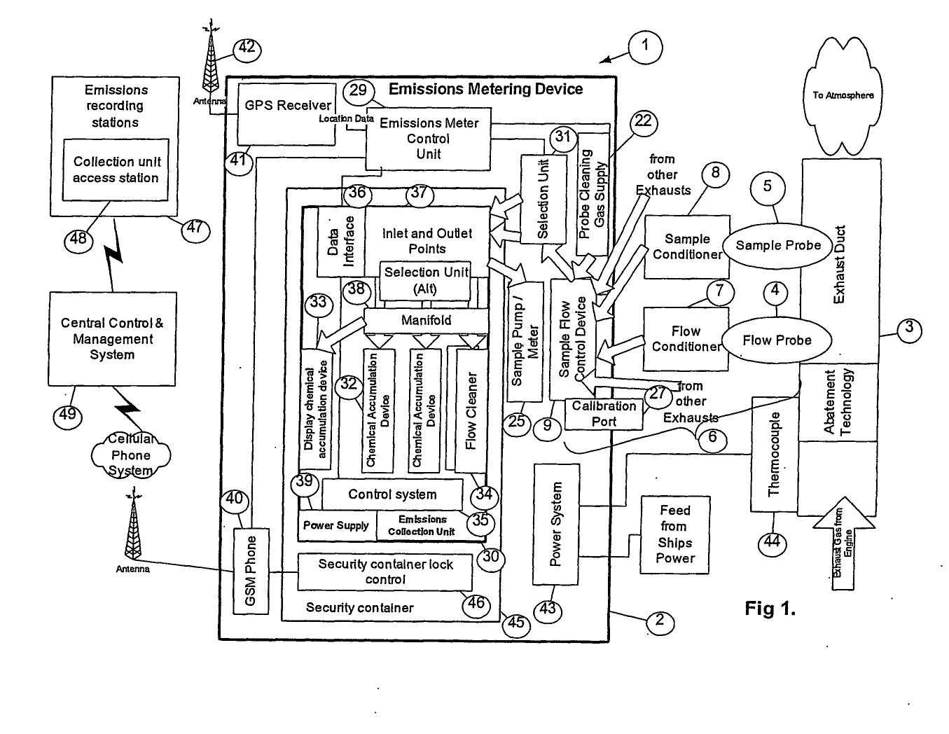

FIG. 1 shows a block diagram of an emissions measuring system in accordance with the present invention.

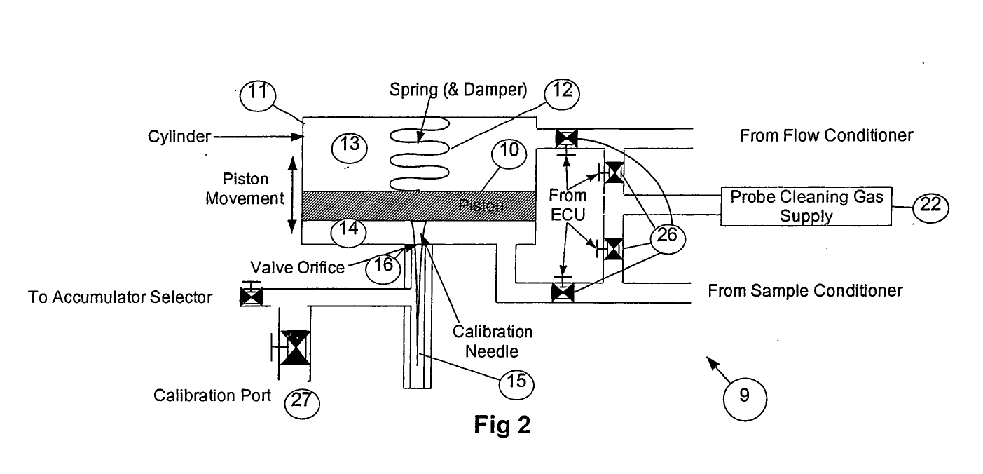

FIG. 2 illustrates one embodiment of a sample flow control device.

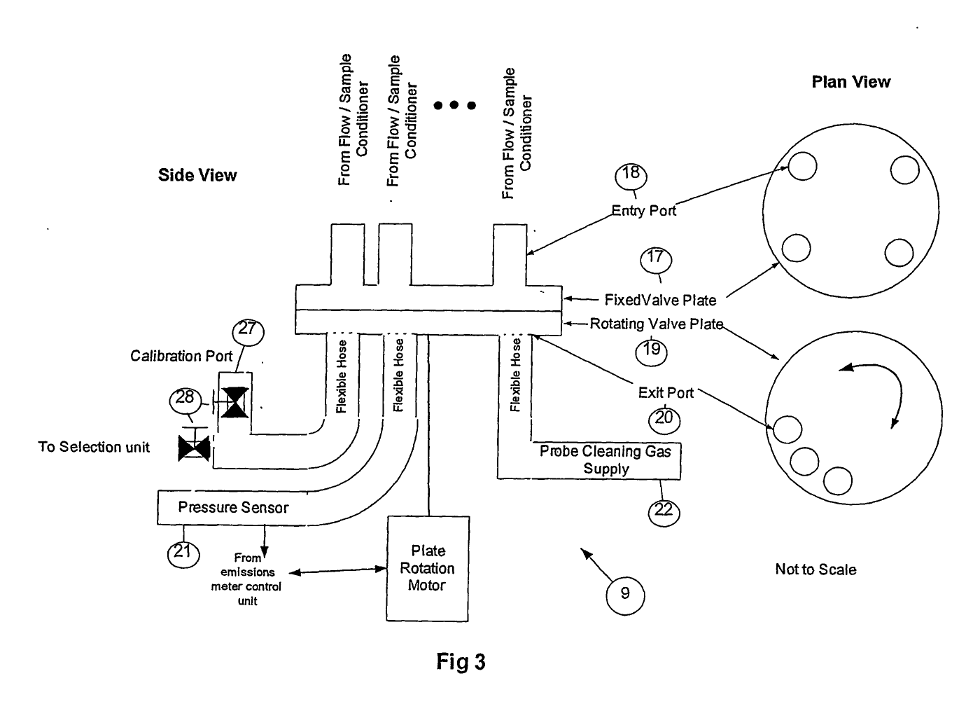

FIG. 3 illustrates an alternative sample flow control device.

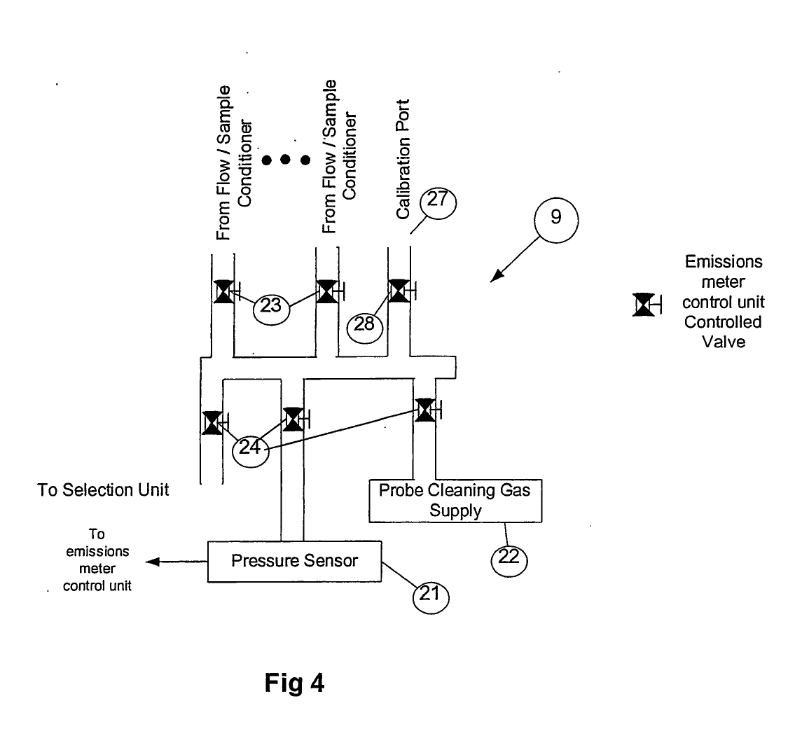

FIG. 4 illustrates another alternative sample flow control device.

A wide range of emissions are potentially measurable by the emissions meter of the present invention. The emission meter of the present invention will be described mainly in relation to exhaust emissions, i. e. fuel emissions to the atmosphere as a result of combustion. However, the present invention is also applicable to other forms of emissions and these will also be described. In practice, sulphur oxides and nitrogen oxides are the exhaust emissions of greatest interest and the following will be explained with reference to, but not limited to, sulphur emissions.

The emissions metering device 1 of the present invention will be described in the context of measuring emissions exhausted from a ship, boat or other sea vessel. However, the invention may also be used in conjunction with other mobile exhaust gas emitters, or even stationary ones, where a measure of the amount of emissions is required, as explained in relation to an aircraft below.

The emissions metering device 1 of the present invention takes a controlled sample of a representative proportion of the exhaust gases or other form of emissions discharge and directs the sample to an appropriate emissions measuring device 2 where emissions react with a reagent to provide a measurement of the pollutants of interest. Alternatively, the emissions can simply be collected and the analysis and measurement of components of interests can take place at a later time. The emissions measuring device 2 is secured against any tampering and unauthorised access. Preferably, the device is arranged in a cabinet secured by a locking system which can only be opened by specific access means when it is time for the emissions measured to be recorded. Preferably, the data obtained is stored, processed, and kept secure by a central control and management system 49.

With reference to FIG. 1 and specifically in relation to exhaust emissions, the emissions sample can be taken from one or several exhaust ducts 3. The exhaust duct 3 is the duct or pipe carrying hot gases from an engine to where it can be released to the atmosphere, usually (in the case of a ship) at the top of a funnel. Many vessels have several exhaust ducts 3, for main engine(s), for auxiliary engine(s), such as generators, and for boilers. Gases that pass through the duct(s) 3 carry the emissions that need to be measured. Emissions from several exhaust ducts 3 may be measured in a single emissions metering device 1 or an emission metering device may be provided for each exhaust duct 3.

The volume of the sample needs to reflect or be a known proportion of the total flow through the exhaust duct or ducts 3 and flow should be controlled in such a way as to ensure the proportionality is accurate and appropriate. In the case of a sample being taken from several exhaust ducts 3 using a single emissions metering device 1, the emissions samples must be mixed in proportion to the flow in each exhaust duct 3.

The emissions sample taken is a known proportion of the total emissions of the vessel. One means for taking the emissions samples from a single exhaust duct 3, as set-out above, is to attach a flow probe 4 and a sample probe 5 to the exhaust duct 3. It is important that the probes are attached to the exhaust duct 3 at a position so the sample taken is in the form in which it would be released to the atmosphere. This is usually at the top of the funnel and should be after any abatement technology used, such as a seawater scrubber, Selective Catalytic Reduction device or FGD equipment.

The flow probe 4 detects the flow rate of the emissions within the duct 3 and thus allows the flow within the probe to be determined. The flow probe 4 may be a venturi probe or any other reliable flow detecting technology. The sample probe 5 is used to extract a representative sample of the gases in the exhaust duct 3. The flow rate is used by a sample flow control device 9 to ensure the sample extracted from the exhaust duct 3 by the sample probe 5 is in proportion to the amount of emissions being extruded through the exhaust duct 3. The flow probe 4 may produce an electronic signal representing the detected flow or may allow gas to flow through it for the purpose of flow measurement at a later stage. In some embodiments, the flow probe 4 and the sample probe 5 may need to be downstream of each other in the exhaust duct to be exposed to a necessary pressure differential. In other embodiments, the sample probe 5 and the flow probe 4 may be integrated into a single probe device.

The device may also include a flow conditioner 7 and a sample conditioner 8. Should the flow probe 4 function in a way that requires emissions extraction, the flow conditioner may process the gas, i.e. clean or cool it, to condition it to a suitable form for later use. The sample conditioner 8 acts to cool and dry the usually hot and humid sample exhaust gases in a controlled way so that only acceptable changes occur to the chemistry of the sample, which should not affect the detection of the exhaust gases of interest. Any changes that do occur to the amount of exhaust gases of interest in the sample should be consistently quantifiable so that these can be compensated for.

The sample flow control device 9 forms part of the sample system 6, along with the flow probe 4 and the sample probe 5, and serves to control the flow of the sample emissions extracted from the exhaust duct 3 and pass the sample(s) to the measuring device 2. The sample flow control device 9 when used in conjunction with multiple emission sources or ducts 3 combines the emissions in proportion to the flow rate from each source 3. This means that the volumes of exhaust gases passed on for each sample stream are proportionate to the flow in each sample stream. This allows more than one engine to be measured simultaneously using a single emissions metering device 1.

Any sample flow control device 9 can be used that is capable of passing on the emissions to the measuring device 2 in proportion to the flow rate of the emissions source 3. Two specific examples are envisaged in relation to the sampling of exhaust emissions and are described below. It should be borne in mind that other forms of sampling a known proportion of emissions dischage, could also be used, for example in the case of other forms of emissions, such as non-gaseous emissions.

One possible embodiment uses an analogue sample flow control device 9, as shown in FIG. 2, which operates by using the pressure differential between a flow probe 4 and a sample probe 5 to modulate the aperture of a flow constriction valve. A piston 10 is slidable within a cylinder 11 and moves against a spring 12 located in the upper chamber 13 and connected at either end to the upper surface of the piston 10 and the cylinder ceiling. The upper chamber 13 is in flow communication with the flow conditioner 7 and hence the flow probe 4. The lower chamber 14 is in flow communication with the sample conditioner 8 and hence the sample probe 5. The calibration needle 15 is attached to the bottom of the piston 10 which slidingly moves in and out of a valve orifice 16 and thus changes the cross section of the orifice 16 open to the flow of emissions.

The pressure differential between the flow probe 4 and the sample probe 5 is a function of the flow of emissions within the exhaust duct 3. As the pressure differential in the exhaust changes the piston 10 moves either up or down and thus expands or contracts the area of the valve orifice 16 open to the flow of emissions. This provides the function of controlling the volume of emissions in proportion to the flow of emissions in the exhaust duct 3. The shape of the needle 15 is chosen when the sample flow control device 9 is calibrated to ensure that the sample flow corresponds to a fixed proportion of the exhaust flow. A standard range of needles 15 could be available corresponding to known engine types.

This type of sample flow control device 9 will be connected to just one emission source 3, which is acceptable when emissions are being measured using a separate emissions metering device 1 for every exhaust duct 3. In the case where multiple exhaust ducts 3 are being sampled by a single emissions metering device 1, it will be necessary to combine the emissions from each sample flow control device 9 before passing them on to the emissions measurement device 2. This can be done in any way provided that the combined emissions is a proportional representation of the flow of emissions from each source 3. The device described below is one example of proportionate combination from multiple sources.

A different possible sample flow control device is illustrated in FIG. 3. This embodiment simplifies proportionate emissions sampling from multiple exhaust ducts 3. In this embodiment, the flow probe 4 and sample probe 5 may be integrated into a single device.

The fixed valve plate 17 includes a sample emissions inlet port 18 in flow communication with the sampled emissions via the flow/sample conditioner 7,8 and the flow/sample probe 4,5 for each emissions source 3. A rotating valve plate 19 is attached thereto in a gas tight arrangement. The rotating valve plate 19 has, at least, a sample emissions outlet port 20 in communication with the emissions measurement device 2. It may also include further outlet ports 20 in communication with a pressure sensor 21 or a probe cleaning gas supply 22.

A pressure sensor 21 can be utilised in communication with an outlet port 20, which will detect the pressure experienced at the probe 4,5 in the exhaust duct 3. This pressure reading can be used to calculate the flow rate in the exhaust duct 3.

The inlet ports 18 and outlet ports 20 are positioned so that, by rotation of the rotating valve plate 19, a flow path can be established between any inlet port 18 and one, and only one, outlet port 20. The rotating valve plate 19 is controlled to rotate to open the appropriate inlet/outlet paths as required. For example, if a pressure reading is needed for a particular emissions source then the rotating valve plate 19 is rotated to establish flow communication between the inlet port 18 specific to that exhaust duct 3 and the outlet port 20 to the pressure sensor 21. An electronic signal will then be produced corresponding to the pressure measurement for conversion to a flow rate measure. The pressure may also be measured using a separate pressure probe in the exhaust duct 3 which provides an electronic signal representing the pressure in the same way as above. Alternatively, a separate flow rate measuring device could be used to supply an electronic signal detailing the flow rate in the exhaust duct 3.

The flow rate information is used to select the timing of the rotation of the lower valve plate 19 so the emissions supplied from each inlet port 18 are mixed in the correct proportions. Basically, the greater the flow rate in the exhaust duct 3, the longer the flow path for that particular emissions inlet port 18 will be open for emissions flow to the emissions measuring device 2.

Another possible version of the sample flow control device 9 is shown in FIG. 4. This has a similar construction to that shown in FIG. 3 except that the flow of emissions to and from the inlet 18 and outlet ports 20 is electronically controlled with valves 23,24. The inlet ports 18 are opened by the inlet valves 23 and the outlet ports 20 are opened by the outlet valves 24. The inlet ports 18 can be operated in two ways. They can be opened one at a time, for a period of time in proportion to the emissions flow rate in each exhaust duct 3, in a similar way to the way the sample flow control device 9 of FIG. 3 works. Alternatively, the valves 23,24 can all be opened at the same time, with the extent of flow being dependent on the flow rate in their respective exhaust ducts 3. Either way, the volume of emissions from each source in the combined emissions outputted to the emissions measuring device 2 reflects the flow rate in their respective exhaust ducts 3. The outlet ports 20 are opened one at a time for emissions flow to the emissions measuring device 2 or to the pressure sensor 21 or any other required device.

It is possible that the probes 4,5 in the exhaust duct 3 could become clogged, as the exhaust gases may include particles and other materials that can accumulate on the probes A,5 or the sample lines. This can be remedied using a blast of air travelling in the reverse direction, i.e. towards the exhaust duct 3. This would function to blow away any accumulated particles from the flow 4 and/or sample probes 5 and leave them free of blockages. The cleaning gas is provided from a probe cleaning gas supply 22, such as a gas cylinder, which can be replaced as a consumable for the emissions metering device 1. The cleaning gas is ideally inert. An alternative source is the discharge from the measuring device 2 which exits through the sample pump and meter 25, which will be described in more detail later.

The valves 26, as shown in FIG. 2, are controlled to enable a blast of gas from the probe cleaning gas supply 22 to be passed back out through the sample probes 4,5. These valves 26 are controlled so the probes 4,5 are cleaned from time to time, as necessary depending on the likely state of the probes 4,5, without the sample gases being passed on to the sample flow control device 9. Similarly, with reference to FIG. 4, the valves 23,24 are controlled to force cleaning air back through the probes 4,5 by alternately having one emissions outlet port 20 in flow communication with the cleaning gas supply 22. The sample flow control device 9 shown in FIG. 3, will also have an emissions outlet port 20 in flow communication with a cleaning gas supply 22. When cleaning is required, the lower plate 19 is rotated to establish flow communication with each flow/sample probe 4,5 individually to force a blast of cleaning air through it in the reverse direction. The arrangement of the outlet ports 20 on the lower plate 19 prevents the cleaning gas from travelling to any of the other outlet ports 20.

Calibration ports 27 are provided with the sample flow control device 9 for intercepting the sample emissions before they reach the emission measuring device 2. There are many characteristics specific to an individual ship that will affect the calibration of the sample extraction system, such as the engine size and type, duct shape, location of probes and other features. Upon installation of the emissions metering device 1, measurements will need to be taken under controlled conditions to ensure that the samples taken and used are accurately representative of the ships emissions. The sample flow control device 9 controls valves 28 to close off the supply to the emissions measuring device 2 and opens the calibration ports 27 to divert the sampled emissions to the calibration equipment. The accuracy of the sample proportion needs to be verified as well as the accuracy of the emissions measurements. The calibration ports 27 pass conditioned samples to external instruments so that the various characteristics can be empirically measured. Once known, these characteristics are used to calibrate the emissions metering device 1.

In an alternative embodiment, instead of measuring the emissions directly, the amount of the components of interest of the emissions could be derived from the fuel burned. This embodiment would require taking a sample of the fuel actually used in each relevant sea area which is a controlled proportion of the actual fuel consumption and specific to each relevant sea area.

An analysis of the fuel sample will establish the average characteristics of the fuel used in each sea area and from this information, the amount of each emission component released in the exhaust could be calculated, if necessary.

Virtually all marine engines are diesel engines, with fuel injected directly into cylinders of hot compressed air. The injectors may be under the direct control of an engine management system, or driven by mechanical pumps, driven by a mechanism shared by all cylinders.

One method of sampling the fuel actually used in a marine engine would be by using a fuel injector, under the same control and from the same fuel feed system as the engine whose emissions are being measured, which would take a sample from the fuel being injected that is directly proportionate to the main engine consumption. The fuel injector would aim to take a very small proportion of the fuel and would, optionally, return a portion of the fuel passed through the fuel injector back into the fuel recirculation system. This serves to further reduce the scale of the fuel taken by the emissions meter, perhaps reducing the scale of the sample by 1:10 or 1:100. Other methods of sampling are feasible, and which are preferably an integral part of the overall engine design.

In another embodiment of the present invention, water resulting from shipboard processes may be the emission being measured for the quantities of certain components of interest contianed therein. In this embodiment, a sample of water will need to be taken from an appropriate point in the water processing system. The sample will need to be a controlled proportion, as with the emissions meter which takes a controlled sample of the exhaust gases described above. The size of the sample of the process water taken will be proportionate to the total flow, only scaled by a large reduction factor to ensure a manageable sample size.

The measurement of the amount of certain components of interest in sea water used for scrubbing exhaust gases has a further application beyond gaining information on the amount of the component of interest in the process water. It is possible to assess the exhaust emissions based on information about the fuel used and an assumed reduction factor achieved by the scrubbing system. This reduction factor assumption will not be valid if the scrubber is bypassed or switched off in some way. However, an appropriate and proportionate sample of the water involved in the scrubbing process would enable quantification of departures from the expected properties and volumes of the discharge water, and so enable verification of the reduction factor.

In another embodiment, the emission meter could be used to measure components of interest in ballast water. The sampling stage will involve extracting a sample from the discharge water, and making the sample proportionate to the volume of discharge water. The sample is reduced in volume, by a fixed and known proportion, with the disposed of water being first filtered to prevent the smallest feasible organism passing through the filter. This ensures that any organisms of interest, such as those classified as “viable organisms”, are not lost from the sample.

Importantly, irrespective of the emission being measured, the sample must be a controlled proportion of the overall amount of the emission. Thus, it can be seen that the emission meter of the present invention is applicable to numerous types of emissions. Nonetheless, the present invention will continue to be discussed primarily with regard to exhaust gas emissions.

Referring back to FIG. 1, the sample flow control device 9 thus passes to the emissions measuring device 2 volumes of exhaust samples controlled to reflect the total flow through the exhaust duct(s) 3. The emissions measuring device 2 comprises all the means necessary for measuring the various components of interest of the emissions supplied by the emissions sampling system 6. The emissions measuring device 2 contains three main components: the emissions meter control unit 29, the emissions collection unit 30 and, in preferred embodiments, the selection unit 3 1.

The collection unit 30 is a transferable enclosed unit, which, while fitted within the emissions metering device 1 of the present invention, accumulates the samples from the sample flow control device and cumulatively measures the components of interest of the samples. The collection unit is removed from time to time, to allow the measured emissions to be read and recorded e.g. at a processing station or laboratory, and a fresh collection unit 30 can take its place.

The emissions measurement may be performed by any reliable means which provides an indication of the quantity of a particular component in a gas sample. This can be achieved by on-board accumulation of the specific components of interest, or accumulation of the sample of emissions containing that componet of interest for later ananlysis. Component accumulation can be done in two ways, both involve passing the emissions through an appropriate chemical reagent to achieve a change in the reagent, which can be measured. This change can be quantified by measuring the chemical or physical change e.g. change in weight that has occurred to the reagent. The alternative is to produce a qualitative measure by observing a colour change in the reagent. The preferred technique uses chemical accumulation devices 32 which are sealed within the collection unit 30. The collection unit 30 may contain one or a plurality of accumulation devices 32, which may or may not contain chemical reagents. Accumulation devices containing chemical reagents are containers for chemicals which react with the particular emission component of interest and whose chemical or physical properties change in dependence on the quantity of emission component present. The emissions accumulation devices 32 may have a single entry and a single exit point. The emissions containing the component of interest pass into the chemical accumulation device via the entry point and may leave at the gas exit point as required.

In one embodiment, the accumulation device 32 contains a chemical which reacts with or adsorbs the emissions as they pass through, resulting in a change in the reagent. This change in the reagent should be quantifiable, allowing a reading of the cumulative amount of the components of interest in the emissions to be obtained. By selecting an appropriate reagent for the desired emissions component of interest, and as long as the characteristics of the controlled exposure of the emissions to the reagent are known, then the cumulative measurement of the component of interest in the ship's emissions can be inferred from the accumulated component on the reagent.

Alternatively, or in addition, a chemical accumulation device 32 may be used where the reagent changes colour when it is brought into contact with the emissions component of interest. The extent of the colour change of the reagent may be viewed through a transparent window and allows a qualitative measure of the accumulated emissions component of interest. A colour changing or display chemical accumulation device 33 may be useful to include in the emissions metering device 1 behind transparent windows through which such display chemical accumulation devices 33 can be viewed. This will provide ship personnel with an approximate measure of the emissions. This may help, for example, with on-board decisions related to emissions. A controlled portion of the incoming emissions could be passed to one or more display chemical accumulation devices 33 for this purpose.

A preferred chemical reaction is one by which the change in weight of the chemical accumulation device 32 gives a reliable indication of the quantity of emissions accumulated for the component of interest. However, any method that gives reliable quantitative measures may also be used.

Many chemicals that are useful in a chemical accumulation device 32 are sensitive to multiple emissions. It may therefore be necessary, when measuring certain emissions, to pass the emissions first through flow cleaners 34, which extract unwanted co-emissions to ensure only the chosen emission components of interest are measured in the chemical accumulation device 32. The flow cleaner 34 can contain cleaning chemicals, which will remove components from the incoming emissions that might otherwise interfere with the accumulation of the emissions component of interest. By appropriate selection of the cleaning chemicals, and the sequence of the flow through them, a wide variety of emissions components can be accumulated and measured.

The entry and exit points of the accumulation devices 32 should be mechanically standardised and manufactured to tolerances that allow them to be interchangeable within an individual emissions collection unit 30 and among different collection units 30, and so ensure reliable, repeatable behaviour.

The chemical accumulation devices 32 may be reusable, by recharging the reagent after any measurements have been read out and recorded (described further below). Similarly, the emissions collection unit 30 can be reusable by replacing, recharging or treating any internal components where this is necessary such that it is reliably reusable.

The accumulation devices 32 should, preferably, be uniquely identifiable by, for example, a bar code or a unique number or other code, so the use of the accumulation device 32 within the emissions metering device 1 can be tracked. This identification means is especially important when the emissions measurements are being read out and recorded e.g. at a central location, to record the emissions measurements from a plurality of sources e.g. several different ships.

The emissions collection unit 30 may include its own control system 35 with memory and security means to capture, maintain, secure and, as appropriate, describe events affecting the collection unit 30. This control system 35 may be embedded onto a smart card. The events of interest include charging with reagent, connection to the emissions collection unit 30, information about the sampling history, the accumulation device 32 unique identification means, disconnection from the collection unit 30, connection to emissions reading and recording equipment and quantified measurement results. The collection unit control system 35 may be powered by a small battery or from the power means of the emissions metering device 1.

The emissions collection unit 30 also includes a data interface 36, which provides the data connection between the emissions collection unit 30 and any external devices, such as the emissions meter control unit 29, the emissions measuring device 2 and any means required to read and record the measured emissions. This data interface can be of any form, but is preferably of IT industry standard, such as a USB fitting so as to minimise costs.

The emissions collection unit 30 contains emissions inlet and outlet points 37, through which emissions can enter and exit the emissions collection unit 30. These provide a mechanical interface to any external device that the emissions collection unit 30 is connected to, such as the emissions metering device 2 or the means for reading and recording the measured emissions. The data interface 36 may be incorporated into this mechanical emissions interface. If the emissions collection unit 30 is in a detached state, the emissions inlet and outlet points 37 should be securely sealed to prevent contamination of the accumulation devices 32. These seals are preferably only opened when inserted into an appropriately keyed receptacle. In one form, multiple emissions connections are made between the emissions inlet and outlet points 37 to connect to all the pipes of the external emissions carrying network, transporting emissions to and from the emissions collection unit 30. The emissions inlet and outlet points 37 of the same configuration are manufactured such that they will readily fit with all devices to which the emissions collection unit 30 can be connected to with the same configuration.

Emissions flow within the emission collection unit 30 needs to be controlled so that the emissions pass from the inlet points of the emissions collection unit 30 and through the appropriate flow cleaners 34 and accumulation devices 32 or display accumulation devices 33 and to the outlet points. The emissions flow within the emissions collection unit 30 is controlled by the manifold 38, which is the internal pipe work arrangement, which interconnects the various accumulation devices 32 and the emissions inlet and outlet points 37 of the emissions collection unit 30. The emissions are passed to the various accumulation devices 32 and, if used, display accumulation devices 33 in known proportions, so the emissions released by the ship can be calculated from the emissions components measured in each accumulation device 32.

The manifold 38 may be designed to have a detachable or separate configuration plate component that configures the flow arrangement to the particular use. This will allow a more standardised manufacture of the emissions collection unit 30, yet maximise the flexibility of the nature of the measurements possible. Any such configuration plate would also have standard connections to the collection unit control system 35, so the configuration is also recordable and auditable.

The emissions collection unit 30 may optionally include an internal power supply 39 to provide power to the emissions metering device 1 of the present invention. This will allow the emissions metering device 1 to be a self powering independent piece of equipment that does not need any other power source from the ship.

The collection unit 30 may contain alternative accumulation devices depending on the emission being measured. In the case of sampled fuel or seawater used in ship processes, the reagent will be selected to react with the component(s) of interest in these emissions, for example, sulphur and hydrocarbons, respectively. Alternatively, no reagent could be used and the sample of the fuel used or processed seawater could simply be stored in the accumulation devices for off-ship analysis. Similarly, in the case of sampled sewage discharge or ballast water, the collection unit may contain reagents which will react with the emissions components of interest or the collection unit may have no reagents and just stores the sample.

For example, the reagents used for measurement of components of interest in ballast water may enable discrimination between organisms that were viable at the point of sampling, and those that were not. The reagent may, for example, be designed to be taken up by and participate in viable organisms' metabolism so the reagents' presence in an organism contained in the sample would show the viability of the organism at the time of the sampling. The preferred reagent would cause death of the organism as soon as a detectable amount of the reagent had been metabolised. Alternatively, accumulation devices may include mechanisms to preserve or prevent the destruction of the viable organisms in the sample. This may include controlled nutrient release or light energy input. If this is done, the methods chosen must enable extrapolation backwards so that the number of organisms at the time the sample was taken can be calculated.

The detection of VOCs in a sample of cargo outgas may be done by thermal desorption, although other reagents may be used depending on the component of interest in the cargo outgas.

The emissions meter control unit 29 is a computer system overseeing and controlling the operation of other units, retaining a memory of events, receiving information from external devices and sending information to external systems and devices. The emissions meter control unit 29 may comprise conventional computer technology.

The emissions meter control unit 29 includes communication means for sending and receiving information. This is preferably a general system mobile (GSM) ‘phone 40 providing communication from the emissions meter control unit 29 to any external systems. The GSM ‘phone 40 is provided with an encryption system to authenticate connections and to protect communications. Other ‘phone or communications technologies may be used, so long as they have similar levels of protection, and, in the case of ships, the ‘phone will need to operate to standards used at all the main ports visited by the ship. In a preferred embodiment, use can be made of standard encryption tools and services of mobile telephones to provide secure and authenticated communication between parts of the system such as between the emissions collection unit 30 and/or the control unit 29 and e. g. the recording station 47 or a control centre. If desired, security of communication can be enhanced by further encryption using knows encryption techniques.

External communication means 40 can be used to send a signal when the emissions collection unit 30 should be changed, when the ship is at a port, and which port the ship is at. There is no need for continuous communication, although for some vessels this may be useful, and for these a satellite communication device may be an option.

Data communicated from the emissions meter control unit 29 concern the events happening to the emissions metering device 1, such as changes of emissions collection unit 30 and any alarm or status signals. The emissions control unit 29 will monitor the overall health of the emissions metering device 1 and its components, analyse them and react, usually by sending an alarm signal if maintenance or repair is required.

A sample pump 25 is in flow communication with the outlet point 27 of the emissions collection unit 30 to draw air, in the case of gaseous emissions, therefrom by pumping at a constant pressure. This drawing of air from the outlet point 27 facilitates the flow of emissions through the emissions metering device 1. An optional extra feature is a flow meter 25, indicating the total volume of sample pumped and thus verifying the proper functioning, or otherwise, of the sample system 6 by comparing this volume with the volume of emissions that was supposed to be sampled. This comparison will be performed by the emissions control unit 29, which will trigger an alarm signal if the system is improperly functioning. This alarm signal will be externally communicated by the communication means 40.

The emissions meter control unit 29 will preferably include a global positioning system (GPS) 41 of any kind, or some other type of locating or positioning system, to determine the ship's position. This information is used by the emissions meter control unit 29 to determine whether the vessel is in an emissions control area and, if so, which area. The information on the various emissions control areas is stored by the emissions meter control unit 29. The emission control unit 29 will receive updates on boundaries of sea areas, for example via GSM telephone 40, which will be used in conjunction with information from the GPS by the emissions meter control unit 29 to establish which emissions control area the ship is located in. The various sea areas will not change often, but when it does happen the emissions meter control unit 29 can be updated quickly and reliably. Alternatively, the GPS may be required to detect other sea areas, such as harbours or other specified areas, which are particularly sensitive to the release of certain emissions, such as sewage or ballast water or where emissions information for the area is particularly required.

The communication means 40 and the global positioning means 41 of the emissions metering device 1 may be provided with an antenna 42 which allows communication of satellite signals for the GPS 41 and two way communication with the cellular network for the GSM 40.

The emissions restrictions applied may be time dependent, for example the end of an emission trading year or for a pollutant with varying seasonal effects. The emissions meter control unit 29 may, thus, also include some means for determining the time of year. Alternatively, it could receive time of year information from the communication means.

In the case of exhaust gas sampling, the emissions meter control unit 29 receives the flow or pressure measurements from the sample flow control device 9 detailing the flow rate or pressure in the various exhaust pipes 3. The emission meter control unit 29 uses this information to control the volume of emissions from multiple exhaust ducts 3 being passed on by the sample flow control device 9. It does this by either controlling valves or, in the sample flow control device 9 of FIG. 3, the rotation of the rotating plate 19. The emissions meter control unit 29 also controls the cleaning of the sample 4 and the flow probes 5, by appropriately controlling the valves to perform a reverse blast of the cleaning gas. Where other forms of emissions have been sampled, the control unit 29 will still control the amount of sample being taken as a controlled proportion of the total emissions discharge flow rate.

In the illustrated embodiment, the calibration valves 28 are controlled by the emissions meter control unit 29 at calibration time.

The emissions meter control unit 29 receives information from the collection unit control system 35 concerning any relevant history of the emissions collection unit 30, and to send and record in the emission collection unit control system 35 relevant events and status. This communication is transferred via the collection unit data interface 36 and should be protected by encryption.

The emissions flow from the sample flow control unit 9 is a representative sample of the total emissions from the vessel. The importance and value of the sample, generally, depends upon where the vessel is, which is preferably determined by the emissions control unit. The location of the vessel is important for ship emissions measurement as there may be no emissions restrictions in some sea areas and in ECAs where emissions restrictions apply, the exact emissions restriction may vary within different ECAs. Alternatively, there may be little interest in the emissions in certain sea areas as compared to others. The selection unit 31 serves to either stop the emissions flowing to the accumulation devices 32 when the vessel is outside an emissions control area, or other sea area in which emissions quantities are of interest, or chooses accumulation devices depending on the nature of the emissions control area. For example, a harbour, or a particular sea area, may have different emissions restrictions and the selection unit 31 allows different totals to be determined for each sea area This is important as it allows the emissions being released in each different sea area to be known relative to the different emissions restrictions.

Another application of the invention may be in measuring aircraft emissions. Such emissions may have a greater impact on the environment because of the height at which they occur. The system of the invention could be adapted to make the emissions measurements dependence on height as well as (or even instead of) geographical location.

In one embodiment, therefore, the system may be adapted such that emissions measuring only occurs when the vessel is within an emissions control area and, where different areas have different restrictions, the selection unit 31 also allows the selection of the correct pipes for feeding the emissions to the designated accumulation device 32 for the current emissions control area. This is preferably all controlled by signals sent from the emission meter control unit 29, which uses the vessel's current location and emissions control area boundary information to send the appropriate electronic signal to the selection unit 31. Such a system of directing the sample to an accumulation device depending upon the location of the emissions meter is applicable to all of the various types of samples which could be taken for measuring emissions, including fuel samples, ballast water, process water, cargo outgas, sewage, etc.

The selection unit 31 also allows selection of the accumulation devices 32 used, for example, if there is a time boundary, such as the end of a trading year or period. If necessary, different totals for different periods can be measured. The time boundaries may also be seasonal, as some emissions at certain times of year may be more harmful than similar emissions at other times of year, meaning that emissions restrictions may also be seasonal, requiring separate measurement. Again, this is preferably controlled by signals sent from the emissions meter control unit 29, which uses the time of year determining means to establish an appropriate signal.

The emissions metering device 1 can be made in numerous configurations. For example, the emissions metering device 1 may include just a single set of accumulation devices 32 if the ship only operates in a single emissions control area or other sea area in which emissions quantities are of interest or even just a single accumulation device if only one type of pollutant is to be measured. Accumulation devices 32 in this configuration are only needed for each emissions component of interest being measured. A set of accumulation devices 32 includes enough devices 32 so that each emissions component of interest can be measured. The emissions collection unit 30 may alternatively contain more than one set of accumulation devices 32, to allow for different emissions control areas or other sea area in which emissions quantities are of interest, different ports visited and different times of year. Thus, the emissions metering device 1 can be made available in different configurations, with choices as to the number of accumulation devices 32, which will have a consequence on the frequency of which the emissions collection unit(s) 30 will need to be changed.

The selection unit 31 can be installed outside the emissions collection unit 30, where it will form the emissions interface with the sample flow control device 9, or inside the emissions collection unit 30, where the inlet and outlet points 37 will form the emissions interface with the sample flow control device 9. Incorporating the selection unit 31 within the emission collection unit 30 means that only a single inlet and outlet point 37 is needed between the emissions collection unit 30 and the sample flow control device 9 and the various connections between the selection unit 31 and the accumulation devices 32 will be via the internal manifold 38. This offers a more universal system for connecting the emissions collection unit 30 to external devices, as this will fit with all external devices having a single inlet and outlet point regardless of the internal configuration of the emissions collection unit 30.

A wide range of emission components can be measured with sets of accumulation devices 32. It is envisaged that multiple emissions collection units 30 could be connected into a single emission metering device 1. Alternatively, many accumulation devices 32 can be stored in a single emissions collection unit 30. Either way, the manifold 38 will need to be appropriately set up such that sets of accumulation devices 32 are individually accessible to emissions. This can be done with either multiple inlet and outlet points 37 to the emissions collection unit 30 or just a single inlet and outlet point 37 and a more intricate manifold 38 as described above.

The emission meter control unit 29 may require further functionality depending upon the type of emissions being measured. For example, ballast water discharge is a non continuous process, so the emissions meter control unit will need to monitor the status of the main ballast water activity—pumps and valves—to know when to take samples. In some circumstances, the history of the status information, when associated with the geographical location, may be enough to establish proper and adequate processes in ballast water processing, and the accumulation devices 32 may be emptied without analysis. Also, in the case of cargo outgas emissions, status signals may be used to detect when one cargo is fully discharged, and when a new cargo is starting to be loaded. The ability to distinguish between emissions from different cargoes may be an important feature. This may mark a change in the responsibility for the emissions, and so is used in addition to the geographical location information to select the accumulation device 32 for the sample.

The whole emissions metering device 1 can be powered by any means, provided the emissions metering device 1 always has power necessary to operate. The power system 43 feeds power to all components of the emissions metering device 1 that need it, and can, but need not necessarily, include a battery, so that the emissions metering device 1 can function without external power for a period if necessary. Power input may be from the ship's normal power by conductive connection to a ship power line. However, it is preferable that the emissions metering device 1 can operate independently of the ship's power or local power feeds to ensure the emissions metering device 1 is always operating and is secure against power supply tampering and is not restricted in its positioning by having to be close to ship power lines. Alternatively, in one embodiment, in particularly, but not exclusively, in the case of exhaust emissions, the emissions metering device 1 will be located in close proximity to the hot exhaust duct 3 but will itself operate at lower temperatures. Any means of thermoelectric power generation could make use of this heat differential to provide enough power to run the device. Preferably, a thermocouple device 44 is attached to the hot exhaust as the hot end of the thermoelectric generator. If all the exhaust ducts are cold, then the engines are not running and so no emissions are occurring, meaning the emissions metering device 1 can power down.

The emissions collection unit 30 is preferably locked within a security container 45 that forms part of the emissions metering device 1. The sample flow control device 9 is included in the security container 45 with the emissions measuring device 2.

The security container 45 is mechanically secure from tampering and locked to prevent any unauthorised access. The internal components of the security container 45, such as the emissions collection unit 30, can only be accessed by the appropriate key or code. The locking and unlocking of the security container 35 is, preferably, controlled by a security container lock control 46. The locking means can be of any type, e. g. a key, a swipe card etc., but is preferably arranged such that it can only be opened from the inside by reception from the communication means 40 of an appropriate encrypted signal. The signal can be of many types, but preferably contains a unique signal and/or personal identification number from an accredited communication device, and preferably received within a prearranged time span. The accredited communications device is preferably a cellular phone.

Using mobile communication as a “key” for opening locked doors, cabinets and containers improves security, particularly where this is used such that the enclosure can only be opened via a secured communication channel. Thus no external keyhole is required. Again, the secured and authenticated communication, provided in mobile telephones ensures that only authenticated mobile telephones of authorised users can be used to open and gain access to the tamper-proof container. Security can be further enhanced using PIN codes communicated via a GSM short message service or the like.

The security container 45 opening procedure is preferably secured to an extent such that if it were opened in any other way it would have to be by force, which would provide irrepressible evidence of tampering. One example opening procedure would be as follows: an emissions metering device operative is instructed to replace an emissions collection unit 30 in an emissions metering device 1. The operative uses an accredited communications device having the GSM number of the emissions metering device 1, which is in communication with the security container lock control 46, and the unique PIN. A time window during which the operative should attempt to open the security container 45, the operative's cellular phone number and the unique pin is communicated to the security container lock control 46. The operative then, once physically located at the emissions metering device 1 calls the number of the GSM telephone 40, and enters the unique PIN. Only when the encryption, the PIN, the time slot and the GSM number and the cellular number are all verified, will the security container lock control 46 trigger the opening procedure.

The security container opening procedure involves first sealing and securing the emissions collection unit 30, and then opening the security container 45, giving the operative access to the enclosures of the security container 45.

The closing procedure involves closing the security container 45, locking it, sending an external communication reporting such and unsealing and connecting the emissions collection unit 30.

The emissions collection units 30 are removed from time to time for analysis, maintenance and emissions reading and recording, as necessary. The emissions control unit 29 sends a signal via the communication means 40 e.g. when the ship is docked at a harbour and the emissions collection units 30 can be collected and replaced. The collection units 30 are removed as described above and replaced with regenerated or new emissions collection units 30.

To ensure proper regulation, the measured emissions will need to be read out and recorded before regeneration and reuse. Where official regulatory checks need to be made, this is, preferably, performed at emissions recording stations or processing laboratories 47, located in various areas across the world. The emission recording station 47 process the retrieved emissions collection units 30 by measuring and recording the accumulated emissions for each accumulation device 32. The emissions collection devices 30 can then be recharged with known quantities of reagents, and sealed and then returned to appropriate vessels for re-use. These processes will need careful tracking and must operate under stringent quality controls to guarantee to emissions metering device clients and emissions regulators that the emissions are as measured and recorded.

The emissions collection unit 30 may be opened by any means which allows restricted access, but preferably using a keyed probe which is specifically keyed only for the purpose of opening the emissions collection unit 30. This will allow access to its internal components in case of repair, recharging, maintenance or emissions component accumulation read-out, extraction and replacement of the accumulation device 32, or any other reason.

The emission recording station 47 may include at least one collection unit access station 48, which accepts the emissions collection unit 30 in the same way as the emission metering device 1 connects to the emissions collection unit 30, thereby unsealing the emission inlet and outlet points 37 (which are sealed during transportation). The collection unit access station 48 will open the emissions collection unit 30 in order to be able to read and record the emissions accumulated. This may require the collection unit access station 48 to include a keyed probe to unlock the emissions collection unit 30 to allow access to the accumulation device 32 for reading of the measured emissions. The collection unit access station 48 will also perform recharging or replacing of the accumulation devices 32, and communication of any necessary information, such as event information or, for example, performing read out and recharging processes, are sent to the memory of the collection unit control system 35, via the data interface 36.

Any means may be used to determine the emissions measurements from the collection unit 30 as discussed above, for example quantifying the accumulated emissions by comparing the weight of the accumulation device 32 before and after their installation in and emissions metering device 1.

The emission recording station 47 will be in communication with a central control and management system 49. The central control and management system 49 will store and keep secure all records relating to each accumulation device 32. The emission recording station will identify each individual accumulation device 32 by a uniquely identifiable code, such as a bar code or a serial number, as discussed above. Upon reading and recording emissions accumulation measurements from a particular accumulation device 32, the emissions measurements and other relevant information are sent to the central control and management system 49. The information is sent by any data transfer means, but preferably via the Internet.

The central control and management system 49 is a secure system that maintains records of emissions metering devices 1, the ships on which they are installed, all emissions collection units 30, all the emissions recording stations 47, the emissions details of every ship with an emissions metering device 1 installed and all emissions accumulation devices 32. It holds records on all of the security container controls and the mobile phone numbers associated with them. It may provide an electronic service to emissions metering devices clients, distributing the evidence of emissions as appropriate. It provides services to central emissions metering device managers and controllers. It may be feasible to operate with only a single global central control and management system 49, or there may be several, with each emissions recording station 47 in communication with at least one central control and management system 49.

The central control and management system 49 provides all data communications to and from the emissions meter control unit 29 via the emissions meter communication means, the emissions recording stations 47, the collection unit lock control 46, and the communication means of the emission metering device operative. These data communications are encrypted to verify the correct recipients and senders and ensure secure data transfer. AU external communications required to control the security protection means for opening and closing the security container 45 are provided from the central control and management system 49. All sea boundary information is provided from the central control and management system 49 which also receives and reacts to any alarm or status signals.

The software controlling the central control and management system 49 may be licensed to emissions certification services. Furthermore, the emissions recording station 47 may be licensed under franchise to operate the emissions analysis systems and working to the specified quality and audit standards as set out.

Thus, the system provides a secure and reliable train of emission collection, measurement and recordal which should satisfy stringent regulations, if desired.

1.-24. (canceled)

25. An apparatus for measuring emissions comprising:
means for obtaining a sample flow (9), the sample flow being a controlled proportion of the total emissions to be measured;
means for accumulating said sample flow in a housing, said housing containing one or more known chemical reagents with which the accumulated samples react to provide a measure of one or more selected components within said sample, said means for accumulating comprising a plurality of separate accumulation devices, each containing at least one respective chemical reagent, characterized in that said housing is tamper-proof, and in that the apparatus further comprises means (41) for detecting the location of the apparatus; and switching means (31) adapted to direct the sample to one or other of said accumulation devices according to geographical location and/or time of year or adapted to switch the accumulating means on or off depending upon location and/or at selected times.

26. The apparatus of claim 1, further comprising:
a cleaning chemical or cleaning arrangement to remove components which might otherwise interfere with the accumulation of the component to be measured.

27. The apparatus of claim 1, further comprising:
an automatic time determining system which is set to switch the device on and off at selected times.

28. The apparatus of claim 1, wherein
said means for obtaining the sample flow is adapted to take extracts from the exhaust ducts (3) of several engines and then to mix them, in proportion to the flow from each exhaust duct, and then pass the combined sample to the means for accumulating.

29. The apparatus of claim 1, further comprising:
display means (33) for providing a visual indication of said measure.

30. The apparatus of claim 1 wherein
said tamper-proof housing is a tamper-proof removable canister.

31. The apparatus of claim 6, wherein:
said canister is locked inside a tamper-proof cabinet (2).

32. The apparatus of claim 7 wherein said tamper-proof cabinet is adapted to be unlocked by a signal from a wireless communication means.

33. The apparatus of claim 8 wherein said tamper-proof cabinet is adapted to be unlocked by a signal from a mobile telephone.

34. The apparatus of claim 1, wherein
the apparatus is provided with its own power supply (43).

35. The apparatus of claim 10 wherein said power supply is a battery.

36. The apparatus of claim 1, wherein:
said tamper-proof housing has an inlet port (37) adapted to receive the sample flow of emissions containing components to be measured,
wherein the inlet port is adapted to be sealed when said container is disconnected from receiving emissions.

37. The apparatus of claim 1 wherein
said housing is adapted to be connected to an external device (48) and to communicate with said external device to provide information about the emission measures.

38. The apparatus of claim 13 wherein said housing communicates with said external device by mobile telephone communication.

39. The apparatus of claim 14 where said communication is encrypted.

40. The apparatus of claim 1 wherein
an interface between the housing and the means for obtaining the sample is sealed and secure.

41. The apparatus of claim 14 wherein
an interface between the housing and said external device is sealed and secure.

42. The apparatus of claim 1 wherein the tamper-proof housing is removable under authorised conditions only and transportable and adapted to be connected to an external device (48) under authorised conditions only.

43. The system of claim 18 wherein
the removable device is provided with encrypted identification means.

44. The apparatus of claim 19, wherein the tamper-proof housing is provided with means for locking the housing, and means for unlocking the housing by means of a signal from a mobile telephone.
